(19) United States
(12) Patent Application Publication
(10) Pub. No.: US 2007/0034038 A1
(43) Pub. Date: Feb. 15, 2007

(54) Pedal assembly for a vehicle

(75) Inventors: Kazuyuki Horie, Nagoya-city (JP); Tetsuo Hariu, Kariya-city (JP); Yasunori Kobayashi, Toyohashi-city (JP); Hiroshi Nakamura, Nishio-city (JP); Masao Kano, Gamagori-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/501,111

(22) Filed: Aug. 9, 2006

(30) Foreign Application Priority Data
Aug. 9, 2005 (JP) 2005-230557

(51) Int. Cl. G05G 1/14

(52) U.S. Cl. 74/512

(57) ABSTRACT

A pedal assembly is disclosed that includes a gear having a first tooth with a root and terminal ends. The gear rotates due to an input force. The assembly also includes a rack having a second tooth with root and terminal ends. The second tooth meshes with the first tooth at a contact point such that rotation of the gear causes linear movement of the rack. The assembly further includes a biasing member that biases the rack. The assembly additionally includes a slide member on which the rack slides. The slide member is provided on a side of the rack opposite to that of the gear such that the rack pushes on the slide member due to meshing of the first tooth and the second tooth.

### CROSS REFERENCE TO RELATED APPLICATION

The following is based on and claims priority to Japanese Patent No. 2005-230557, filed Aug. 9, 2005, which is herein incorporated in its entirety by reference.

### FIELD OF THE DISCLOSURE

The follow generally relates to a pedal and, more specifically, relates to a pedal assembly for a vehicle.

### BACKGROUND

Pedal assemblies have been proposed that electrically detect the amount of rotational displacement of a pedal using a rotational angle sensor or the like. An accelerator pedal assembly, for instance, controls the throttle opening depending upon the detected amount of displacement of the accelerator pedal away from an at-rest position. U.S. Pat. No. 5,529,296 (Japanese Patent No. 3185498), U.S. Pat. No. 6,745,642 (Leaflet of International Patent Publication No. 01/019638), and European Patent No. 0748713 each describe such a pedal assembly.

These pedal assemblies generate hysteresis characteristics between the rotational displacement of the pedal and the input force supplied by the driver. More specifically, a moving member is pushed on a slide member in an amount that depends upon the pedal displacement. The pushing force of the moving member on the slide member increases as the displacement of the accelerator pedal is increased. Therefore, frictional force between the moving member and the slide member increases with an increase in the displacement of the accelerator pedal.

For the device of U.S. Pat. No. 5,529,296, however, the frictional force increases or decreases as the moving member moves in the direction of an axis of rotation of the accelerator pedal. Therefore, the size of the pedal assembly may need to be increased in the direction of axis of rotation.

Further, the devices of U.S. Pat. No. 6,745,642, and European Patent No. 0748713 include tilted surfaces that slide relative to each other. As such, local wear may occur where the tilted surfaces slide against each other.

### SUMMARY

A pedal assembly is disclosed that includes a gear having at least one first tooth with a root end and a terminal end, wherein the gear rotates due to an input force. The assembly also includes a rack having at least one second tooth with a root end and a terminal end, wherein the second tooth meshes with the first tooth at a contact point such that rotation of the gear causes linear movement of the rack in a first linear direction. The assembly further includes a biasing member that biases the rack in a second direction, which is opposite to the first linear direction. Additionally, the assembly includes a slide member on which the rack slides in the first and second direction, wherein the slide member is provided on a side of the rack opposite to that of the gear such that the rack pushes on the slide member due to meshing of the first tooth and the second tooth. As the gear rotates, the contact point successively moves on one of the first tooth and the second tooth away from the root end toward the terminal end thereof. The contact point successively moves on the other of the first tooth and the second tooth away from the terminal end toward the root end thereof, depending upon the direction of rotation of the gear.

A pedal assembly is also disclosed that includes a gear having at least one first tooth, wherein the gear rotates due to an input force. The assembly also includes a rack having at least one second tooth that meshes with the first tooth such that rotation of the gear causes linear movement of the rack in a first linear direction. The assembly further includes a biasing member that provides a biasing force to the rack in a second direction, which is opposite to the first linear direction. Additionally, the assembly includes a slide member on which the rack slides in the first and second direction. The slide member is provided on a side of the rack opposite to that of the gear such that the rack pushes on the slide member due to meshing of the first tooth and the second tooth. The biasing force increases with an increase in the amount of linear displacement of the rack in the first direction, and friction between the slide member and the rack increases with an increase in the amount of linear displacement of the rack in the first direction.

### BRIEF DESCRIPTION OF THE DRAWINGS

FIG. 1 is a schematic view of a pedal assembly according to one embodiment of the invention;

FIG. 2 is a schematic view illustrating the forces transferred between a rack and a gear of the embodiment of FIG. 1; and

FIG. 3 is a diagram of characteristics illustrating a relationship between the rotational angle of the accelerator pedal and the input force on the pedal supplied by the driver.

### DESCRIPTION OF THE PREFERRED EMBODIMENTS

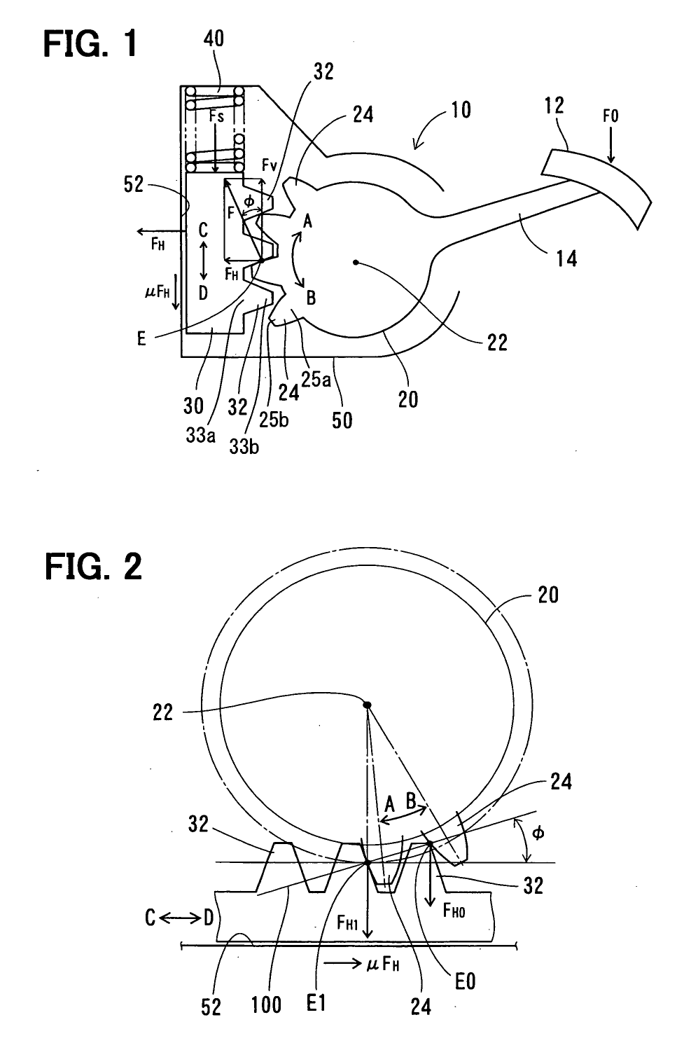

Referring initially to FIG. 1, one embodiment of a pedal assembly 10 is shown. In one embodiment, the pedal assembly 10 is an accelerator pedal assembly 10.

The accelerator pedal assembly 10 includes an accelerator pedal 12 and a gear 20 coupled via an arm 14. The pedal assembly 10 also includes a rack 30. The gear 20 and the rack 30 are enclosed within a housing 50. In one embodiment, the gear 20, rack 30, and the housing 50 are made of a resin material having relatively high resistance to wear (e.g., POM (polyacetal), TEFLON™, or the like.

The gear 20 includes a plurality of first teeth 24. In the embodiment shown, there are a select number of first teeth 24 localized adjacent the rack 30, and the first teeth 24 are spaced away from each other around a portion of the circumference of the gear 20. In the embodiment shown, the first teeth 24 are shaped so as to be involute teeth. As such the width of the first tooth 24 at a root end 25a is larger than the width of the first tooth 24 at a terminal end 25b, and the surfaces between the root end 25a and the terminal end 25b is curved outward.

The rack 30 includes a plurality of second teeth 32. The second teeth 32 are spaced linearly on the rack 30 in a direction perpendicular to an axis of rotation 22 of the gear 20. In the embodiment shown, the second teeth 32 are shaped so as to be tapered teeth. In other words, the width at a root end 33a of the second tooth 32 is larger than the width at a terminal end 33b of the second tooth 32, and the surfaces between the root end 33a and the terminal end 33b is flat.

The first teeth 24 of the gear 20 are in mesh with the second teeth 32 of the rack 30 such that the gear 20 and rack 30 move together. More specifically, when an input force is supplied from a driver to the accelerator pedal 12, the teeth 20 of the gear 20 rotate about the axis of rotation 22 in the directions of arrows A and B, and the rack 30 reciprocally moves in the linear directions indicated by arrows C and D. In the embodiment shown, the rack 30 moves linearly in a direction that is substantially perpendicular to the axis of rotation 22 of the gear 20.

Also, the pedal assembly 10 includes a slide surface 52 on which the rack 30 slides during movement in the C- and D-directions. Relative to the rack 30, the slide surface 52 is positioned on a side opposite to the gear 20. In the embodiment shown, the slide surface 52 is included on the housing 50.

Furthermore, the pedal assembly 10 includes a biasing member 40 that biases the rack 30 linearly in the D-direction. In other words, the biasing member 40 applies a load Fs (i.e., a return force) to the rack 30. In the embodiment shown, the biasing member 40 is a coiled compression spring 40.

Thus, when an input force F0 is applied to the accelerator pedal 12 by a driver, the gear 20 is rotated in the A-direction, and an acting force F is applied from the gear 20 to the rack 30 at an acting angle φ at a contact point E between the first tooth 24 of the gear 20 to the second tooth 32 of the rack 30. As shown, in FIG. 1, the acting angle φ is an angle defined between the acting force F and a direction of linear movement of the rack 30 (i.e., the C-direction).

The acting force F includes a vertical component F_{V} directed along the direction of linear movement of the rack 30 (i.e., the C-direction) relative to the coil spring 40. The acting force F also includes a horizontal component F_{H} directed perpendicular to the slide surface 52. When the coefficient of friction is μ between the rack 30 and the slide surface 52, a frictional force μF_{H} acts between the rack 30 and the slide surface 52 in a direction opposite to the movement of the rack 30.

As mentioned previously, the first teeth 24 of the gear 20 are involute teeth, and the second teeth 32 of the rack 30 are tapered teeth. Thus as shown in FIG. 2, during operation of the pedal assembly 10, the contact point E between the first tooth 24 of the gear 20 and the second tooth 32 of the rack 30 shifts on the same action line 100, for example, from E0 to E1. Therefore, the acting force F is applied to the rack 30 from the gear 20 at the same angle φ despite the rotational movement of the gear 20 and movement of the contact point E. Also, despite the movement of the contact point E, the vertical and horizontal force components F_{V}, F_{H} remain at approximately the same ratio.

Furthermore, as shown in FIG. 2, the position of the contact point E shifts from the root end 25a, 33a of either the first or the second tooth 24, 32 toward the terminal end 25b, 33b thereof and from the terminal end 25b, 33b of the other tooth 24, 32 to the root end 25a, 33a thereof depending on the rotational direction of the gear 20. For instance, when the gear 20 rotates in the A-direction, the contact point E shifts away from the root end 25a of the first tooth 24 toward the terminal end 25b of the first tooth 24 and away from the terminal end 33b of the second tooth 32 toward the root end 33a of the second tooth 32. Also, when the gear 20 rotates in the B-direction, the contact point E shifts away from the terminal end 25b of the first tooth 24 toward the root end 25a of the first tooth 24 and away from the root end 33a of the second tooth 32 toward the terminal end 33b of the second tooth 32. As such, local wear on the first and second teeth 24, 32 is reduced. Furthermore, since a plurality of first teeth 24 is brought in mesh with a plurality of second teeth 32, local wear is reduced on the teeth 24, 32.

Further, the load Fs which the rack 30 receives from the coil spring 40 increases as the gear 20 rotates in the A-direction and as the rack 30 moves toward the coil spring 40 in the C-direction. An increase in the load Fs is brought about by an increase in the input force F0 from the driver (i.e., the force for depressing the accelerator pedal 12 and necessary for rotating the gear 20 in the A-direction against the load Fs or necessary for holding the gear 20 against the load Fs). In other words, the load Fs increases with an increase in the acting force F. When the acting force F increases as shown in FIG. 2, the horizontal component of force F_{H} for pushing the rack 30 perpendicularly toward the slide surface 52 increases from F_{H0} to F_{H1}. Accordingly, the frictional force μF_{H} increases.

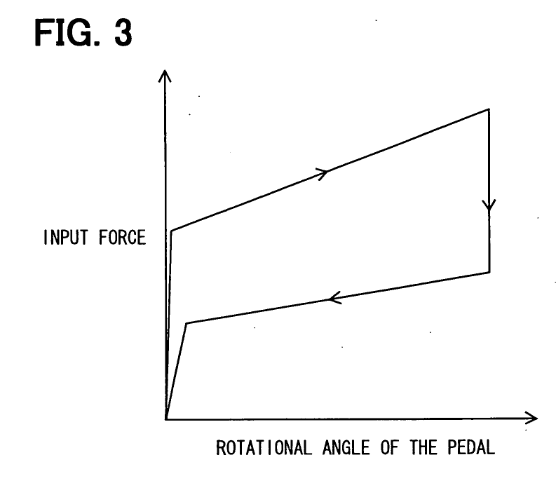

Furthermore, even when the gear 20 rotates and the position of contact point E shifts, the vertical and horizontal components of force F_{V}, F_{H} remain at approximately the same ratio. Therefore, when the rotational angle of the accelerator pedal 12 changes and the acting force F varies, the frictional force μF_{H} varies as well at a constant rate. Accordingly, as shown in FIG. 3, there are generated regular hysteresis characteristics between the rotational angle of the accelerator pedal 12 and the input force F0 of depressing the accelerator pedal 12.

Furthermore, for the gear 20, further, the rack 30 and the slide surface 52 are arranged in a direction at right angles with the axis of rotation 22, enabling the size of the pedal assembly 10 to be reduced in the direction of the axis of rotation 22.

### Other Embodiments

In the embodiment shown, the first teeth 24 of the gear 20 are involute teeth, and the second teeth 32 of the rack 30 are tapered teeth. However, it will be appreciated that the shapes of teeth 24, 32 of the gear 20 and the rack 30 are not limited to those of the illustrated embodiment. Preferably, however, the contact point E successively moves from the root side 25a, 33a of one tooth 24, 32 toward the terminal side 25b, 33b thereof and from the terminal side 25b, 33b of the other tooth 24, 32 toward the root side 25a, 33a thereof in response to the rotation of the gear 20 so as to push the rack 30 onto the slide surface 52.

Furthermore, though the gear 20 and the rack 30 are each illustrated with pluralities of teeth 24, 32, respectively, there may be provided only one tooth 24 and only one tooth 32 depending upon the range of rotational angles of the accelerator pedal 12.

In addition, though the rack 30 in the illustrated embodiment slides directly on the slide surface 52 of the housing 50, the slide surface 52 can be included on something other than the housing 50 without departing from the scope of the present disclosure.

Accordingly, while only the selected embodiments have been chosen to illustrate the present invention, it will be apparent to those skilled in the art from this disclosure that various changes and modifications can be made therein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A pedal assembly comprising:
a gear having at least one first tooth with a root end and a terminal end, wherein the gear rotates due to an input force;
a rack having at least one second tooth with a root end and a terminal end, wherein the at least one second tooth meshes with the at least one first tooth at a contact point such that rotation of the gear causes linear movement of the rack in a first linear direction;
a biasing member that biases the rack in a second direction, which is opposite to the first linear direction; and
a slide member on which the rack slides in the first and second direction, wherein the slide member is provided on a side of the rack opposite to that of the gear such that the rack pushes on the slide member due to meshing of the at least one first tooth and the at least one second tooth;
wherein, as the gear rotates, the contact point successively moves on one of the first tooth and the second tooth away from the root end toward the terminal end thereof, and wherein the contact point successively moves on the other of the first tooth and the second tooth away from the terminal end toward the root end thereof, depending upon the direction of rotation of the gear.

2. A pedal assembly according to claim 1, wherein the gear includes a plurality of first teeth, and wherein the rack includes a plurality of second teeth.

3. A pedal assembly according to claim 1, wherein the first tooth is an involute tooth and the second tooth is a tapered tooth.

4. A pedal assembly according to claim 1, wherein the biasing member is a coiled compression spring.

5. A pedal assembly comprising:
a gear having at least one first tooth, wherein the gear rotates due to an input force;
a rack having at least one second tooth that meshes with the at least one first tooth such that rotation of the gear causes linear movement of the rack in a first linear direction;
a biasing member that provides a biasing force to the rack in a second direction, which is opposite to the first linear direction; and
a slide member on which the rack slides in the first and second direction, wherein the slide member is provided on a side of the rack opposite to that of the gear such that the rack pushes on the slide member due to meshing of the at least one first tooth and the at least one second tooth;
wherein the biasing force increases with an increase in the amount of linear displacement of the rack in the first direction, and wherein friction between the slide member and the rack increases with an increase in the amount of linear displacement of the rack in the first direction.

6. A pedal assembly according to claim 5, wherein the gear includes a plurality of first teeth, and wherein the rack includes a plurality of second teeth.

7. A pedal assembly according to claim 5, wherein the first tooth is an involute tooth and the second tooth is a tapered tooth.

8. A pedal assembly according to claim 5, wherein the biasing member is a coiled compression spring.
